(19) United States
(12) Patent Application Publication
(10) Pub. No.: US 2013/0055580 A1
(43) Pub. Date: Mar. 7, 2013

(54) GARDENING MEASUREMENT TOOLS

(71) Applicant: Eyal Melyon, Burgata (IL)

(72) Inventor: Eyal Melyon, Burgata (IL)

(73) Assignee: GROWEAT, LTD., Kibutz Einat (IL)

(21) Appl. No.: 13/540,976

(22) Filed: Jul. 3, 2012

Related U.S. Application Data
(60) Provisional application No. 61/530,191, filed on Sep. 1, 2011.
(60) Provisional application No. 61/564,312, filed on Nov. 29, 2011.

(51) Int. Cl. G01B 3/28

(52) U.S. Cl. 33/836

(57) ABSTRACT

Gardening measurement tools for determination of sowing depth and correct spread distance are disclosed herein. A first gardening measurement tool is a gauge for measuring depth by inserting the gauge into the soil. A second gardening measurement tool is a measurement tape having predetermined distance illustrations corresponding to a type of plant seed to determine the spread between seeds to be sown in the soil. On the measurement tape different icons are printed, each of which corresponds to a different vegetable, thereby allowing the handling of seeds of different types of vegetables with a single measurement tape.

### CROSS REFERENCE TO RELATED APPLICATIONS

This application claims the benefit of U.S. provisional patent application No. 61/530,191 filed on Sep. 1, 2011 and U.S. provisional patent application No. 61/564,312 filed on Nov. 29, 2011, the contents of which are herein incorporated by reference.

### TECHNICAL FIELD

The invention relates to gardening measuring tools used for the purpose of determination of sowing depth and spread between seeds.

### BACKGROUND

Often is the case when a person, and particularly a child, having limited prior knowledge of gardening, is interested in sowing seeds in order to grow, for example vegetables, in a small lot of land, a pot, and the like. Hand sowing (or planting) requires casting handfuls of seeds over previously prepared soil. However, vegetables have different shapes and sizes and each has its own sowing method, and in particular each has different depths and distances that the seeds should be sown in the soil. This is of course also equally true for plants and bulbs.

It would be therefore advantageous to provide a tool that assists users, in general, and novice users in particular with sowing or planting different types of vegetables and other types of plants.

### SUMMARY

Certain embodiments disclosed herein include an apparatus for creating a cavity in soil and measuring a preferred sowing depth for seed sowing. The apparatus comprises an upper portion including a clip for insertion of a flat object in the clip; a middle portion having a grip area designed to allow easy insertion of the apparatus into the soil, and a bottom portion having a pointed shaft with scale marks allowing a user to measure a depth of the created cavity.

Certain embodiments disclosed herein also include a measurement apparatus for measuring correct spread of speared distance between seeds to be sown. The measurement toll comprises a tape having thereon a plurality of at least a first icon, each of the first icon placed at an equal distance from the previous first icon and the following first icon, wherein the equal distance corresponds to the correct spread of speared distance, and wherein the first icons correspond to a first type of seeds.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIGS. 1A and 1 B are schematic diagrams of a measuring gauge according to one embodiment.

FIG. 2 is a schematic diagram of a measuring tape according to another embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain embodiments disclosed herein include gardening measurement tools for determination of sowing depth and spread, that is comprised of two different tools. A first gardening measurement tool is a gauge for measuring the preferred sowing depth by inserting the gauge into the soil. A second gardening measurement tool is a measurement tape having predetermined distance illustrations that correspond to a type of plant seed to determine the spread between seeds to be sown. On the measurement tape different icons are printed, each of which corresponds to a different vegetable, thereby allowing the handling of seeds of different types of vegetables with a single measurement tape.

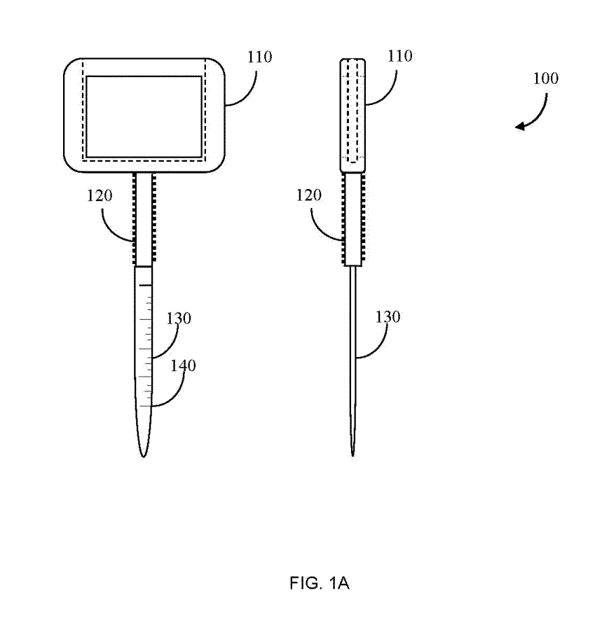

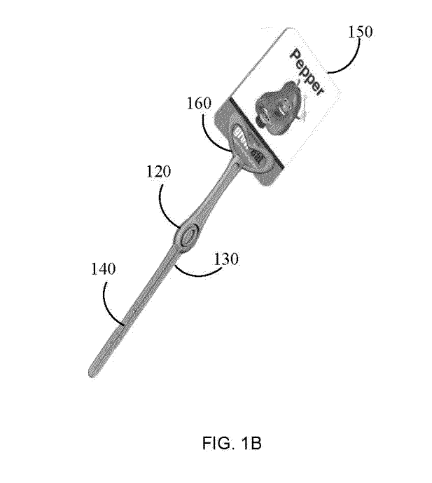

FIGS. 1A and 1B depict an exemplary and non-limiting schematic diagram of a gauge 100 according to one embodiment. As shown in FIG. 1A, the gauge 100 includes three parts which are: a) an upper part comprising a clip 110 for securing of a flat object between the sides of the clip; b) a middle portion 120 having a grip area designed to allow for the turning of the gauge about its length axis for easy insertion of the gauge 100 into the ground; and, c) a bottom portion 130 having a pointed shaft with distance markings 140.

In one embodiment, the clip 110 is at least partially transparent to allow for full viewing of content printed on the flat object, the flat object being, for example, a card with letters and/or at least a drawing corresponding to a seed, bulb or plant. As it is necessary to push the gauge into the soil, and to ensure that it is made easier, especially for those who may have difficulty in doing so, the middle section 120 is provided with a grip area that may be wider, covered with non-slip materials, or have a rough or otherwise coarse surface. The middle section 120 allows for a better grip when twisting the gauge about its longitude axis; or otherwise depressing the gauge 100 into the ground for the purpose of causing the gauge 100 to enter the soil. The depth markings 140 clearly indicate the depth to which the gauge 100 is being entered, thereby providing immediate feedback as to when to cease twisting because the desired sowing or planting depth has been reached. The depth markings may also be marked by numbers clarifying the exact depth.

Once the gauge 100 is inserted to the desired depth, the gauge 100 can be lifted out from the soil and the seed, bulb or plant can be placed in the cavity created in the soil. The gauge 100 can then be placed in the soil nearby as a marker to indicate where growing objects, such as seeds, bulbs or plants, each being of the same type, have been planted.

A flat object, for example a card, can be now inserted in the clip 110 with an indication, written, drawn or photographed, depicting the type of seed, bulb or plant. As illustrated in FIG. 1 B, the clip 110 may be comprised of two essentially parallel sheets of material at close proximity allowing for a flat object, such as an illustrated card 150, to be inserted there between or, as complex as at least one of the sheets having a motion with respect to the other sheet to enable fastening of the flat object inserted into the clip 110. The clip sides may have a variety of shapes, for example, and without limitations, in the form of two heart shaped sides 160.

According to one embodiment, the distance marking 140 on the bottom section 130 may be provided as distance marking printed, engraved, or as bumps or other types of markings. In another embodiment, a screw like spiral (not shown) is used on the bottom section 130. Gaps in the spirals may be used to mark distances at predetermined intervals. In yet another embodiment, the measurement gauge is comprised of a concave structure. Other markings are also possible without departing from the scope of the teaching disclosed herein. In another embodiment, the distance marking may be realized as icons, each of which illustrates a different type of plant seed. Furthermore, combinations of marking types may be used.

A second gardening measurement tool is a measurement tape having illustrations at predetermined distances that correspond to a product, for example, a seed, a bulb or a plant, to determine the preferred planting spread between each plant. Different products correspond to different icons that appear on a measuring tape to allow for the handling of a plurality of products with a single measurement tape.

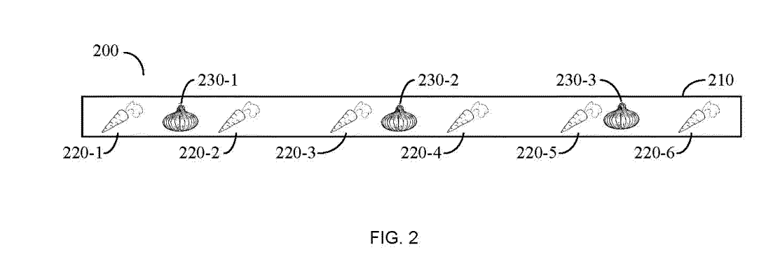

FIG. 2 depicts an exemplary and non-limiting schematic diagram 200 of a measuring tape 210 according to another embodiment. The measurement tape 210 may be made of any kind of flexible or inflexible material, including without limitations various types of metals, synthetic materials and any combinations thereof, and may have a concave shape. In one embodiment, the tape 210 may be placed in a tape housing (not shown).

On the measurement tape 210 instead of or in addition to distance markings in millimeters, centimeters, inches, etc., there are printed, engraved, or otherwise displayed a plurality of icons such as icons 220-1 through 220-6, illustrating a carrot, and 230-1 through 230-3, illustrating an onion. The icons 220 are in distances that correspond to the preferred sowing distance between carrot seeds while the icons 230 are in distances that correspond to the preferred sowing or planting distances between onions. The sowing distances for each of these two vegetables is different, this is reflected in the relative position of the icons 220 and 230 on the measurement tape 210. It should be noted that while the measurement tape 210 was described with icons that correspond to growing objects, i.e., seeds, bulbs, plants and the like, other icons may be used to provide a visual display of distances between objects that correspond to the icons on a measurement tape.

While the present invention has been described at some length and with some particularity with respect to several described embodiments, it is not intended that it should be limited to any such particulars or embodiments or to any particular embodiment, but it is to be construed with reference to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An apparatus for creating a cavity in soil and measuring a preferred sowing depth for seed sowing, comprising:
an upper portion including a clip for insertion of a flat object in the clip;
a middle portion having a grip area designed to allow easy insertion of the apparatus into the soil, and
a bottom portion having a pointed shaft with scale marks allowing a user to measure a depth of the created cavity.

2. The apparatus of claim 1, wherein the clip includes a first part and a second part allowing insertion of the flat object there between of which at least one of the first part and the second part is at least partially transparent.

3. The apparatus of claim 1, wherein the flat object is an illustrated card.

4. The apparatus of claim 1, wherein the distance between the scale marks is marked with numbers.

5. The apparatus of claim 1, wherein the distance between the scale marks includes icons, each icon corresponds to a different type of plant seed, thereby allowing measurement of a correct depth required to sow a particular type of plant seed.

6. The apparatus of claim 1, the bottom portion further includes a screw-like spiral.

7. The apparatus of claim 6, wherein gaps in the screw-like spiral are used as the scale marks.

8. The apparatus of claim 1, wherein the grip allows the easy insertion by at least one of turning of the apparatus around its length, and pushing the apparatus into the soil.

9. A measurement apparatus for measuring correct spread of distance between seeds to be sown, comprising:
a tape having thereon a plurality of at least a first icon, each of the first icon placed at an equal distance from the previous first icon and the following first icon, wherein the equal distance corresponds to the correct spread of distance, and wherein the first icons correspond to a first type of seeds.

10. The measurement apparatus of claim 9, wherein the tape further comprises thereon a plurality of second icons correspond to a second type of seeds.

11. The measurement apparatus of claim 10, wherein the seeds also include bulbs and plants.

12. The measurement apparatus of claim 9, wherein the distance between the icons on the measurement tape is further marked by scale marks.

13. The measurement apparatus of claim 9, wherein the measurement apparatus is comprised of a concave structure.

14. The measurement apparatus of claim 9, further comprising:
a housing in which the tape is placed.
